(19) United States
(12) Patent Application Publication
(10) Pub. No.: US 2019/0002242 A1
(43) Pub. Date: Jan. 3, 2019

(54) MULTIPLE LEADERS FOR LOAD BEARING MEMBER SWAY REDUCTION

(71) Applicant: Otis Elevator Company, Farmington, CT (US)

(72) Inventors: Kyle B. Martin, Avon, CT (US); Peter Keyo, Canton, CT (US)

(21) Appl. No.: 16/023,953

(22) Filed: Jun. 29, 2018

Related U.S. Application Data
(60) Provisional application No. 62/527,292, filed on Jun. 30, 2017.

(51) Int. Cl. B66B 7/06; B66B 9/00; B66B 15/02

(52) U.S. Cl. CPC B66B 7/068; B66B 7/062; B66B 15/02; B66B 9/00

(57) ABSTRACT

A leader system for load bearing member sway prevention of an elevator system includes a plurality of leader members disposed in a hoistway of the elevator system, and a plurality of load bearing member guides each operably connected to at least one leader member of the plurality of leader members. Each load bearing member guide is movable along the hoistway via operation of the elevator system and includes one or more guide elements interactive with a load bearing member of the elevator system to prevent sway of the load bearing member.

### CROSS-REFERENCE TO RELATED APPLICATIONS

This application claims the benefit of 62/527,292, filed Jun. 30, 2017, which is incorporated herein by reference in its entirety.

### BACKGROUND

The subject matter disclosed herein relates to elevator systems. More specifically, the subject matter disclosed herein relates to mitigation of sway of suspension and/or driving ropes for elevator systems.

Elevator systems typically include one or more ropes or other suspension members such as belts from which an elevator car is suspended, and with which the elevator car is driven along a hoistway. Tall buildings in particular, which have elevator systems servicing them, have some sway associated with them. This sway, most often experienced during periods of high winds, can seriously impact elevator performance and, in some instances, damage elevator components. For example, building sway can result in rope sway that, especially when the rope length is shortened as the car runs into an upper or lower landing, has a significant lateral amplitude that causes excessive vertical vibration and noise at the elevator car. Further, rope sway effects experienced at the elevator car are increased at certain floors where the rope sway frequency is at or near the building sway vibratory frequency.

In some systems, rollers or other devices may be utilized to prevent ropes from contacting walls of the hoistway, but such rollers can be costly, especially in buildings with an especially tall rise.

### BRIEF DESCRIPTION

In one embodiment, a leader system for load bearing member sway prevention of an elevator system includes a plurality of leader members disposed in a hoistway of the elevator system, and a plurality of load bearing member guides each operably connected to at least one leader member of the plurality of leader members. Each load bearing member guide is movable along the hoistway via operation of the elevator system and includes one or more guide elements interactive with a load bearing member of the elevator system to prevent sway of the load bearing member.

Additionally or alternatively, in this or other embodiments the plurality of leader members are positioned in the hoistway between a top of the hoistway and an elevator car.

Additionally or alternatively, in this or other embodiments the plurality of leader members are positioned in the hoistway between a bottom of the hoistway and an elevator car.

Additionally or alternatively, in this or other embodiments the plurality of leader members are positioned in a nested arrangement in the hoistway.

Additionally or alternatively, in this or other embodiments the plurality of leader members includes three or more leader members.

Additionally or alternatively, in this or other embodiments each load bearing member guide is operably connected to a leader member via a guide holder.

Additionally or alternatively, in this or other embodiments the guide holder is a pulley around which the leader member is at least partially wrapped.

Additionally or alternatively, in this or other embodiments the leader members are configured for connection to a counterweight of the elevator system.

Additionally or alternatively, in this or other embodiments the load bearing member guides are configured to move along the hoistway in response to movement of the counterweight along the hoistway.

Additionally or alternatively, in this or other embodiments the load bearing member guide includes an eyelet through which the load bearing member extends.

In another embodiment, an elevator system includes a hoistway, an elevator car positioned in the hoistway, a load bearing member operably connected to the elevator car to move the elevator car along the hoistway and a leader system to prevent sway of the load bearing member. The leader system includes a plurality of leader members located in the hoistway and a plurality of load bearing member guides each operably connected to at least one leader member of the plurality of leader members. Each load bearing member guide is movable along the hoistway via operation of the elevator system and including one or more guide elements interactive with the load bearing member to prevent sway of the load bearing member.

Additionally or alternatively, in this or other embodiments the plurality of leader members are located in the hoistway between a top of the hoistway and the elevator car.

Additionally or alternatively, in this or other embodiments the plurality of leader members are positioned in a nested arrangement in the hoistway.

Additionally or alternatively, in this or other embodiments the plurality of leader members includes three or more leader members.

Additionally or alternatively, in this or other embodiments each load bearing member guide is operably connected to a leader member via a guide holder.

Additionally or alternatively, in this or other embodiments the guide holder is a pulley around which the leader member is at least partially wrapped.

Additionally or alternatively, in this or other embodiments the leader members are configured for connection to a counterweight of the elevator system.

Additionally or alternatively, in this or other embodiments the load bearing member guides are configured to move along the hoistway in response to movement of the counterweight along the hoistway.

Additionally or alternatively, in this or other embodiments the load bearing member guide includes an eyelet through which the load bearing member extends.

### BRIEF DESCRIPTION OF THE DRAWINGS

The following descriptions should not be considered limiting in any way. With reference to the accompanying drawings, like elements are numbered alike:

FIG. 1 is a schematic view of an embodiment of an elevator system;

FIG. 2 is a cross-sectional view of an embodiment of a load bearing member for an elevator system;

FIG. 3 is a cross-sectional view of another embodiment of a load bearing member of an elevator system;

FIG. 4 is a plan view of an embodiment of a load bearing member guide for an elevator system;

FIG. 5 is another schematic view of an embodiment of an elevator system;

FIG. 6 is yet another schematic view of an embodiment of an elevator system;

FIG. 7 is still another schematic view of an embodiment of an elevator system;

FIG. 8 is a schematic view of another embodiment of an elevator system; and

FIG. 9 is a schematic view of yet another embodiment of an elevator system.

### DETAILED DESCRIPTION

A detailed description of one or more embodiments of the disclosed apparatus and method are presented herein by way of exemplification and not limitation with reference to the Figures.

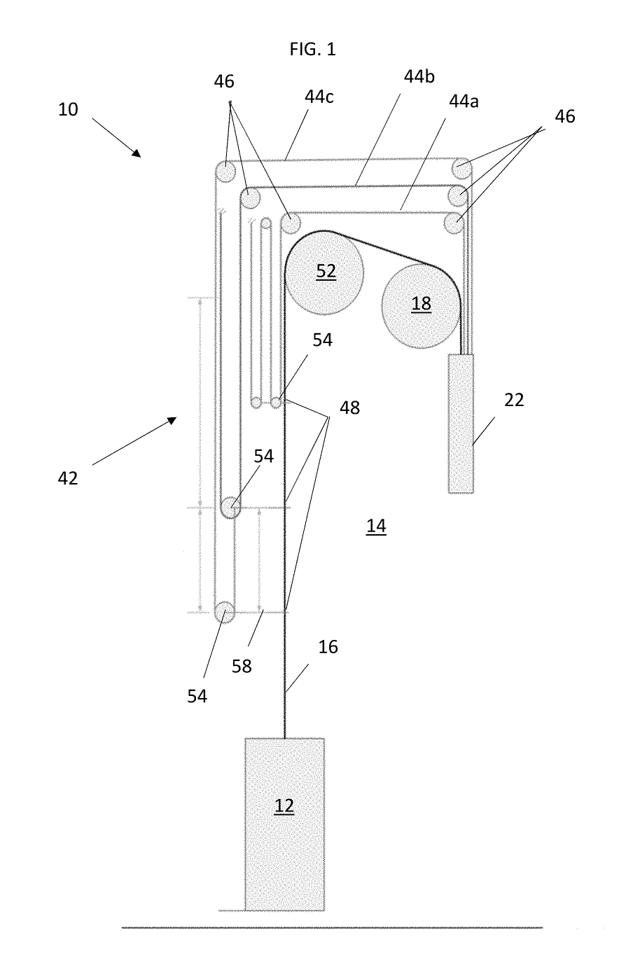

Shown in FIG. 1, is a schematic view of an exemplary traction elevator system 10. Features of the elevator system 10 that are not required for an understanding of the present invention (such as the guide rails, safeties, etc.) are not discussed herein. The elevator system 10 includes an elevator car 12 operatively suspended or supported in a hoistway 14 with one or more load bearing members 16. The one or more load bearing members 16 interact with one or more sheaves 18 to be routed around various components of the elevator system 10. The one or more load bearing members 16 could also be connected to a counterweight 22, which is used to help balance the elevator system 10 and reduce the difference in belt tension on both sides of the traction sheave during operation.

The sheaves 18 each have a diameter, which may be the same or different than the diameters of the other sheaves 18 in the elevator system 10. At least one of the sheaves could be a traction sheave 52. The traction sheave 52 is driven by a machine (not shown). Movement of drive sheave by the machine drives, moves and/or propels (through traction) the one or more load bearing members 16 that are routed around the traction sheave 52. At least one of the sheaves 18 could be a diverter, deflector or idler sheave. Diverter, deflector or idler sheaves are not driven by a machine, but help guide the one or more load bearing members 16 around the various components of the elevator system 10.

In some embodiments, the elevator system 10 could use two or more load bearing members 16 for suspending and/or driving the elevator car 12. In addition, the elevator system 10 could have various configurations such that either both sides of the one or more load bearing members 16 engage the one or more sheaves 18 or only one side of the one or more load bearing members 16 engages the one or more sheaves 18. The embodiment of FIG. 1 shows a 1:1 roping arrangement in which the one or more load bearing members 16 terminate at the car 12 and counterweight 22, while other embodiments may utilize other roping arrangements.

The load bearing members 16 are constructed to have sufficient flexibility when passing over the one or more sheaves 18 to provide low bending stresses, meet belt life requirements and have smooth operation, while being sufficiently strong to be capable of meeting strength requirements for suspending and/or driving the elevator car 12.

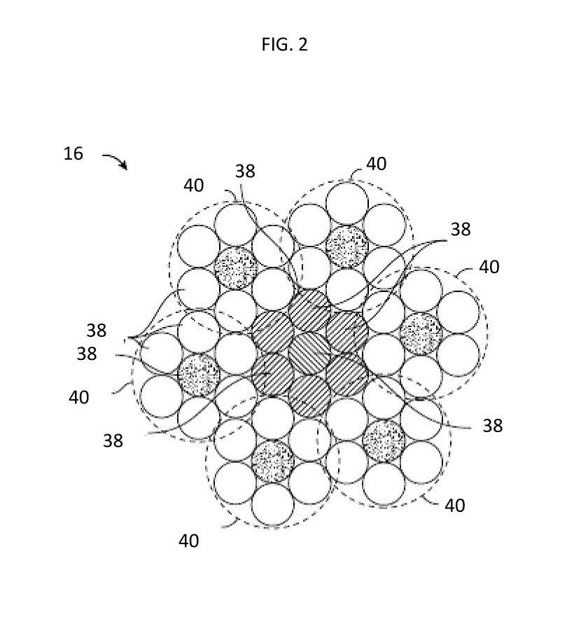

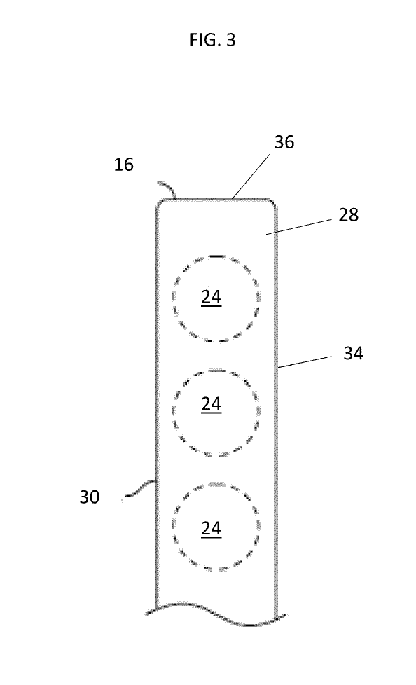

In some embodiments, such as shown in FIG. 2, the load bearing member 16 is a rope, formed from a plurality of steel wires 38, which may be arranged into strands 40. In other embodiments, such as shown in FIG. 3, the load bearing member 16 may be a belt, including a plurality of tension members 24 extending longitudinally along the load bearing member 16 and arranged across a belt width. The tension members 24 are at least partially enclosed in a jacket material 28 to restrain movement of the tension members 24 in the belt and to protect the tension members 24. The belt has a belt width and a belt thickness, with an aspect ratio of belt width to belt thickness greater than one. The belt further includes a back side 34 opposite the traction side 30 and belt edges 36 extending between the traction side 30 and the back side 34.

Referring again to FIG. 1, to reduce and/or prevent sway of the load bearing members 16 during operation of the elevator system 10, the elevator system 10 includes leader system 42. The leader system 42 includes a plurality of leader members 44 positioned in the hoistway 14. The leader members 44 are secured at the counterweight 22 and are routed over a plurality of leader guides 46, which in some embodiments are pulleys or sheaves. The leader system 42 further includes load bearing member guides 48 interactive with the leader members 44 and the load bearing member 16 to prevent sway of the load bearing member 16 in the hoistway 14.

In the embodiment of FIG. 1, the leader system 42 includes three leader members 44a, 44b, 44c in a nested configuration. By “nested” it is meant that at any point in the hoistway 14, a first leader member 44a is located closest to the load bearing member 16 relative to leader members 44b and 44c, and a third leader member 44c is located furthest from load bearing member 16 relative to leader members 44a and 44b. Second leader member 44b is located between leader members 44a and 44c. It is to be appreciated that the use of three leader members 44 is merely exemplary, and that in other embodiments other quantities of leader members 44, such as 2, 4 or 5 leader members 44 may be utilized.

Each leader member 44 is connected to the counterweight 22 and to a respective load bearing member guide 48. In some embodiments, the leader member 44 is connected to the load bearing member guide 48 via a guide holder 54, which in some embodiments is a pulley or sheave around which the leader member 44 is at least partially wrapped. The guide holder 54 and the load bearing member guide 48 are configured to travel or translate in an upward direction in the hoistway 14 as the counterweight 22 moves downward in the hoistway 14, and likewise the guide holder 54 and the load bearing member guide 48 travel downward in the hoistway 14 when the counterweight 22 travels upward in the hoistway 22.

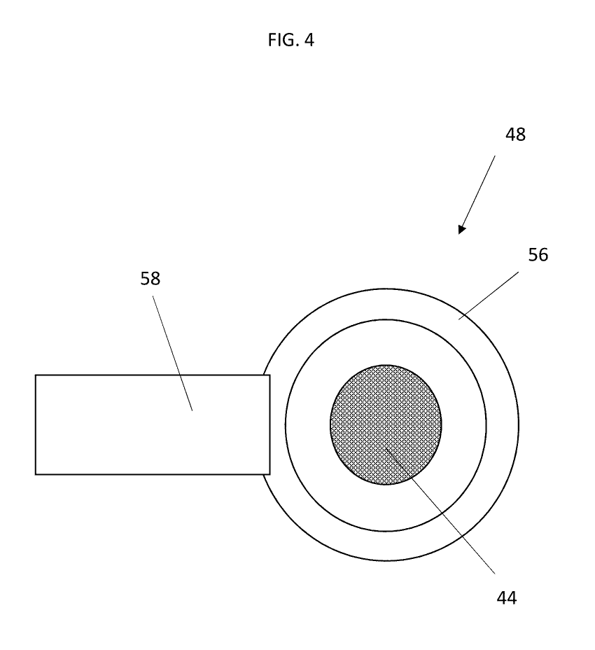

In some embodiments, such as shown in FIG. 4, the load bearing member guide 48 includes an eyelet 56 through which the associated load bearing member 44 is passed, to guide the load bearing member 44. A guide arm 58 may connect the eyelet 56 to the guide holder 54. One skilled in the art will appreciate that the eyelet 56 of the load bearing member guide 48 is merely an example configuration. In other embodiments, other configurations, such as a hook-shape or the like may be utilized.

Referring again to FIG. 1, the leader members 44 may have any suitable roping configurations, such as 3:4, 1:2, 1:4, etc. such that the leader members 44 can be positioned between the elevator car 12 and a top of the hoistway 14. The roping configurations, and the nested arrangement of the leader members 44 allows for a reduction in the space in the hoistway 14 that the leader members 44 occupy.

Further, in some embodiments, the leader members 44 may be interconnected. For example, as shown in FIG. 1, leader member 44c may be coupled to leader member 44b via a connection between leader member 44c and guide holder 54b.

Operation of the elevator system 10 and the leader system 42 will now be described with reference to FIGS. 1, and 5-7. In FIG. 1, the elevator system 10 is illustrated with the elevator car 12 in the lowermost location in the hoistway 14. The load bearing member 16 has a length L between the elevator car 12 and the traction sheave 52. With the elevator car 12 in this position, the load bearing member guide 48b is located at about L/2 from the traction sheave 52, and the load bearing member guide 48c is located at about L/4 from the load bearing member guide 48b. In some embodiments, the load bearing member guide 48a is located at about L/4 from the load bearing member guide 48b.

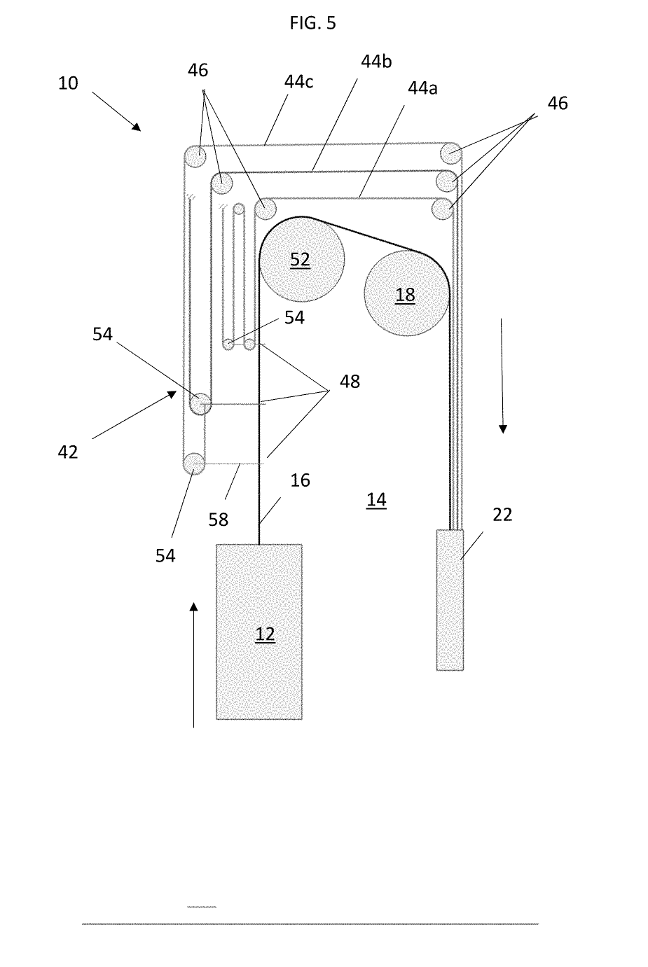

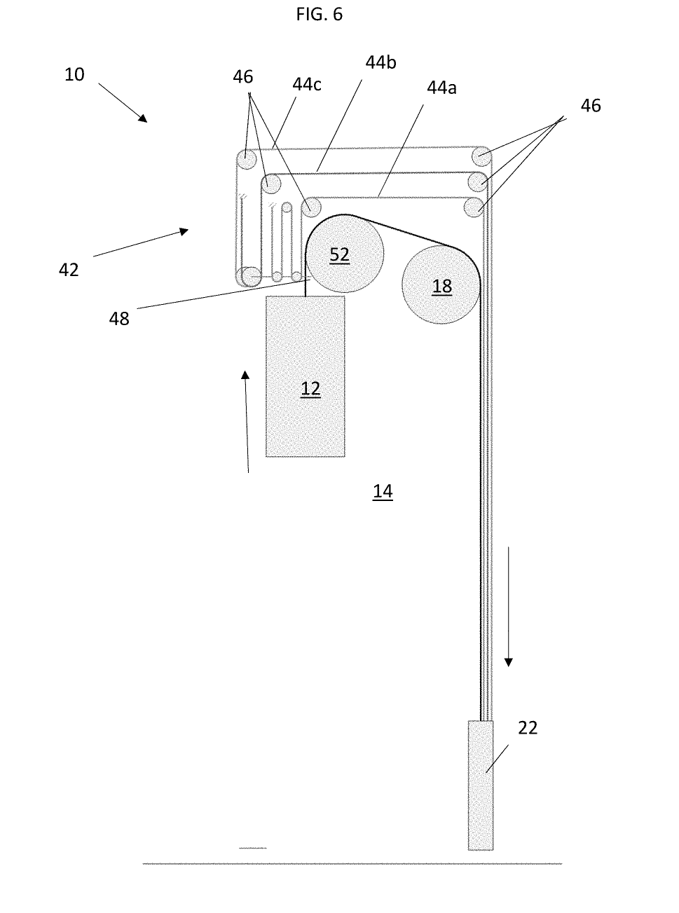

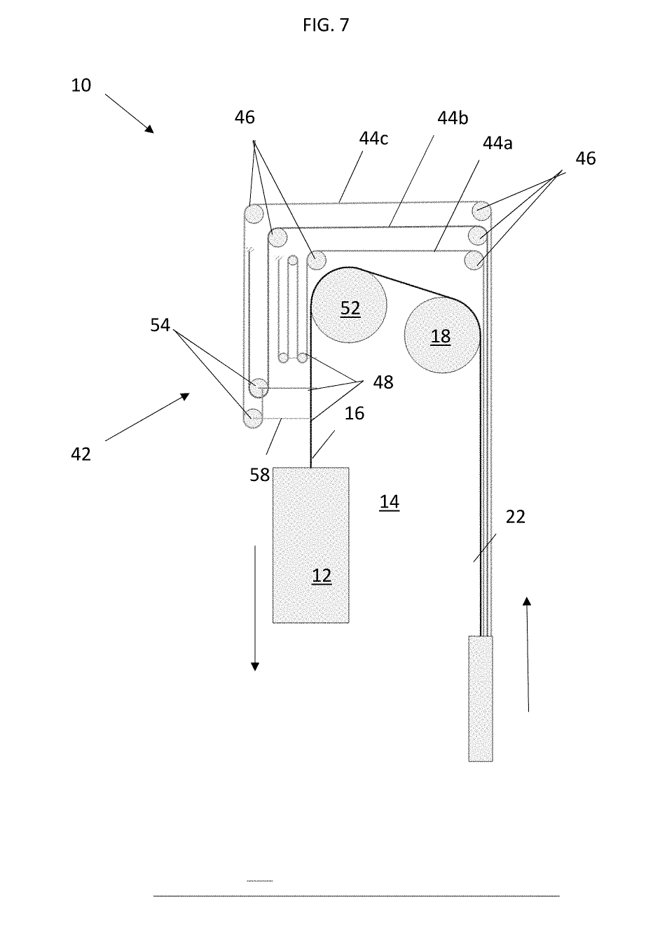

Referring now to FIG. 5, as the elevator car 12 travels upward in the hoistway 14 and the counterweight 22 travels downward in the hoistway 14, the leader members 44 are moved by the movement of the counterweight 22, such that the guide holders 50 and thus the load bearing member guides 48 are urged upward in the hoistway 14. At FIG. 6, with the counterweight 22 located at its lowermost position in the hoistway 14, the load bearing member guides 48 and the guide holders 50 are located at their uppermost position in the hoistway 14. Referring now to FIG. 7, as the counterweight 22 moves upwardly in the hoistway 14, the load bearing member guides 48 and the guide holders 50 move downward in the hoistway 14, and increase a distance between the load bearing member guides 48a, 48b and between load bearing member guides 48b, 48c.

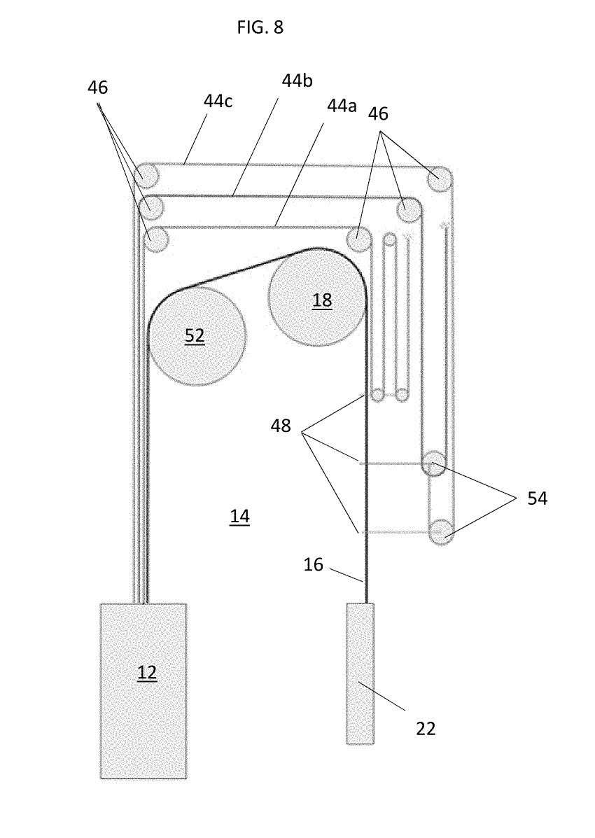

In another embodiment, shown in FIG. 8, the load bearing member guides 48 are arranged along the load bearing member 16 between the counterweight 22 and the sheave 18 to prevent sway of the load bearing member 16 between the counterweight 22 and the sheave 18. One skilled in the art will readily appreciate that load bearing member guides 48 may be utilized to prevent sway of the load bearing member 16 both between the elevator car 12 and the traction sheave 52 and between the load bearing member 16 and the sheave 18.

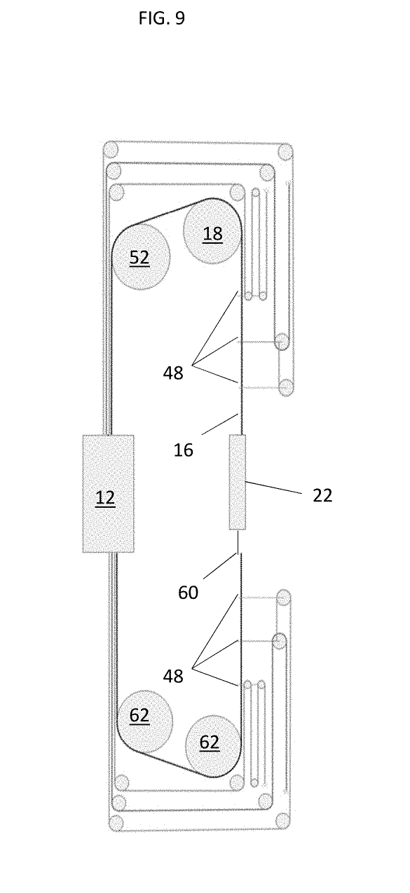

In yet another embodiment, shown in FIG. 9, the elevator system 10 includes a load bearing member configured as a compensation member 60, for example, a rope or a belt, extending below and connected to the elevator car 12 and the counterweight 22, and routed over a compensation sheave 62. In this embodiment, the leader system 42 is positioned and configured to prevent sway of the compensation member 60 between the elevator car 12 and the compensation sheave 62 by positioning load bear member guides 48 along the compensation member 60 between the elevator car 12 and the compensation sheave 62. Additionally or alternatively, the leader system may also be configured to prevent sway of the compensation member 60 between the compensation sheave 62 and the counterweight 22 by positioning load bear member guides 48 along the compensation member 60 between the counterweight 22 and the compensation sheave 62.

The leader system 42 described herein provides continuous guidance for the load bearing members 16, throughout operation of the elevator system 10, preventing sway of the load bearing members 16, which can cause objectionable noise and/or damage hoistway equipment.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A leader system for load bearing member sway prevention of an elevator system, comprising:
a plurality of leader members disposed in a hoistway of the elevator system; and
a plurality of load bearing member guides each operably connected to at least one leader member of the plurality of leader members, each load bearing member guide movable along the hoistway via operation of the elevator system and including one or more guide elements interactive with a load bearing member of the elevator system to prevent sway of the load bearing member.

2. The leader system of claim 1, wherein the plurality of leader members are disposed in the hoistway between a top of the hoistway and an elevator car.

3. The leader system of claim 1, wherein the plurality of leader members are disposed in the hoistway between a bottom of the hoistway and an elevator car.

4. The leader system of claim 1, wherein the plurality of leader members are disposed in a nested arrangement in the hoistway.

5. The leader system of claim 1, wherein the plurality of leader members comprises three or more leader members.

6. The leader system of claim 1, wherein each load bearing member guide is operably connected to a leader member via a guide holder.

7. The leader system of claim 1, wherein the guide holder is a pulley around which the leader member is at least partially wrapped.

8. The leader system of claim 1, wherein the leader members are configured for connection to a counterweight of the elevator system.

9. The leader system of claim 8, wherein the load bearing member guides are configured to move along the hoistway in response to movement of the counterweight along the hoistway.

10. The leader system of claim 1, wherein the load bearing member guide includes an eyelet through which the load bearing member extends.

11. An elevator system, comprising:
a hoistway;
an elevator car disposed in the hoistway;
a load bearing member operably connected to the elevator car to move the elevator car along the hoistway; and
a leader system to prevent sway of the load bearing member, including:
a plurality of leader members disposed in the hoistway; and
a plurality of load bearing member guides each operably connected to at least one leader member of the plurality of leader members, each load bearing member guide movable along the hoistway via operation of the elevator system and including one or more guide elements interactive with the load bearing member to prevent sway of the load bearing member.

12. The elevator system of claim 11, wherein the plurality of leader members are disposed in the hoistway between a top of the hoistway and the elevator car.

13. The elevator system of claim 11, wherein the plurality of leader members are disposed in a nested arrangement in the hoistway.

14. The elevator system of claim 11, wherein the plurality of leader members comprises three or more leader members.

15. The elevator system of claim 11, wherein each load bearing member guide is operably connected to a leader member via a guide holder.

16. The elevator system of claim 11, wherein the guide holder is a pulley around which the leader member is at least partially wrapped.

17. The elevator system of claim 11, wherein the leader members are configured for connection to a counterweight of the elevator system.

18. The elevator system of claim 17, wherein the load bearing member guides are configured to move along the hoistway in response to movement of the counterweight along the hoistway.

19. The elevator system of claim 11, wherein the load bearing member guide includes an eyelet through which the load bearing member extends.
